(19) United States
(12) Patent Application Publication
(10) Pub. No.: US 2026/0195185 A1
(43) Pub. Date: Jul. 9, 2026

(54) APPARATUSES AND METHODS FOR FACILITATING AN INTENT-DRIVEN ENABLEMENT OF END-TO-END NETWORK SLICING

(71) Applicant: AT&T Intellectual Property I, L.P., Atlanta, GA (US)

(72) Inventors: Yuxuan Jiang, Piscataway, NJ (US); Lina Liu, Morton Grove, IL (US); Ajay Rajkumar, Morristown, NJ (US)

(73) Assignee: AT&T Intellectual Property I, L.P., Atlanta, GA (US)

(21) Appl. No.: 19/014,307

(22) Filed: Jan. 9, 2025

(51) Int. Cl. G06F 9/50; G06F 40/30

(52) U.S. Cl. CPC G06F 9/5044; G06F 40/30

(57) ABSTRACT

Aspects of the subject disclosure may include, for example, obtaining an indication of an intent associated with a communication network, defining, based on the obtaining of the indication, a plurality of attributes, identifying a residual resource capacity, determining, based on the identifying, whether the residual resource capacity is sufficient to meet a resource demand represented by the plurality of attributes, resulting in a first determination, and based on the first determination indicating that the residual resource capacity is sufficient to meet the resource demand represented by the plurality of attributes, deploying at least a portion of the residual resource capacity to fulfill the intent. Other embodiments are disclosed.

### FIELD OF THE DISCLOSURE

The subject disclosure relates to apparatuses and methods for facilitating an intent-driven enablement of end-to-end network slicing.

### BACKGROUND

Vast communication networks and systems, and various communication devices, are used to provision communication services. From the perspective of end-users or subscribers, quality of service (QoS) or quality of experience (QoE) are highly desired to obtain data-rich services, for example. Communication network/system operators and service providers are tasked with providing high levels of QoS or QoE, while still ensuring efficiencies in operations. Challenges in efficiencies exist, such as in relation to a utilization of scarce network/system resources to satisfy requirements or specifications.

A supply-and-demand profile in respect of communication resources is rarely static in nature. For example, at various points in time and at various locations, a given resource may be needed at one moment and made available (as spare capacity, for example) at another moment. There are other factors, such as environmental factors (buildings or obstructions in a line-of-sight of communications/signaling, weather impacts, etc.), user-driven changes (e.g., mobility), and the like, that influence network/system performance. What this discussion demonstrates is that network/system operators and service providers would benefit from enhancements in the allocation and utilization of resources to fulfill communication service requests and commitments.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for selecting, allocating, and deploying resources of a communication network or system to satisfy user intent and enhancing efficiencies in operations. Other embodiments are described in the subject disclosure.

One or more aspects of the subject disclosure include, in whole or in part, obtaining an indication of an intent associated with a communication network; defining, based on the obtaining of the indication, a plurality of attributes; identifying a residual resource capacity; determining, based on the identifying, whether the residual resource capacity is sufficient to meet a resource demand represented by the plurality of attributes, resulting in a first determination; and based on the first determination indicating that the residual resource capacity is sufficient to meet the resource demand represented by the plurality of attributes, deploying at least a portion of the residual resource capacity to fulfill the intent.

One or more aspects of the subject disclosure include, in whole or in part, obtaining an indication of an intent associated with a functionality of a communication network; defining, based on the obtaining of the indication, at least one attribute; identifying a residual resource capacity; determining, based on the identifying, that the residual resource capacity is sufficient to meet a resource demand represented by the at least one attribute, resulting in a first determination; and based on the first determination, deploying the residual resource capacity to fulfill the intent, resulting in deployed resources.

One or more aspects of the subject disclosure include, in whole or in part, obtaining, by a processing system including a processor, an indication of an intent associated with a communication service; defining, by the processing system and based on the obtaining of the indication, a plurality of attributes; identifying, by the processing system, a residual resource capacity relative to resources allocated to a baseline load; determining, by the processing system and based on the identifying, that the residual resource capacity is sufficient to meet a resource demand represented by the plurality of attributes; and allocating, by the processing system and based on the determining, at least a portion of the residual resource capacity to fulfill the intent.

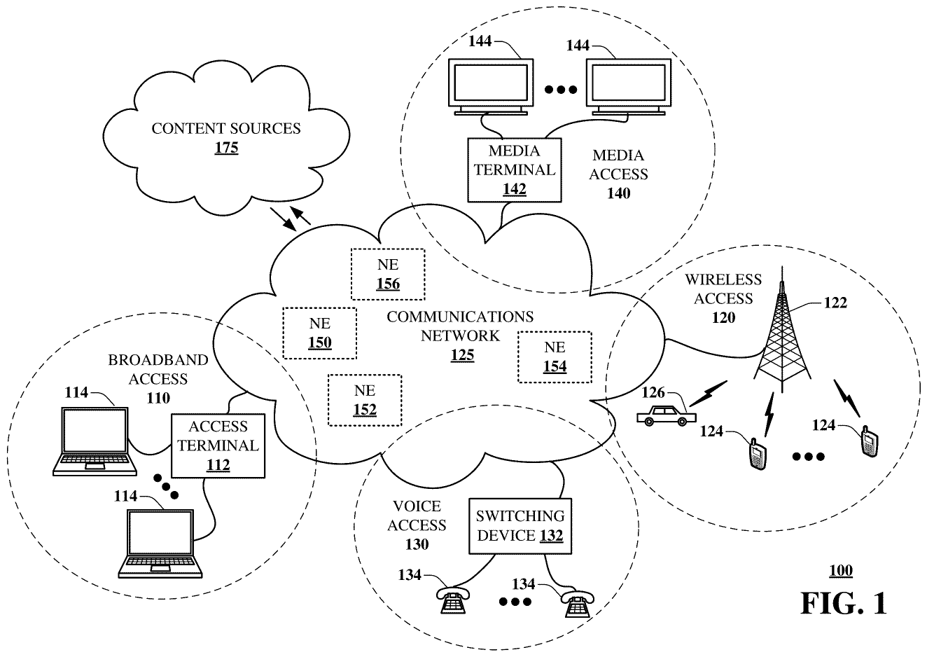

Referring now to FIG. 1, a block diagram is shown illustrating an example, non-limiting embodiment of a system 100 in accordance with various aspects described herein. For example, the system 100 can facilitate, in whole or in part, obtaining an indication of an intent associated with a communication network; defining, based on the obtaining of the indication, a plurality of attributes; identifying a residual resource capacity; determining, based on the identifying, whether the residual resource capacity is sufficient to meet a resource demand represented by the plurality of attributes, resulting in a first determination; and based on the first determination indicating that the residual resource capacity is sufficient to meet the resource demand represented by the plurality of attributes, deploying at least a portion of the residual resource capacity to fulfill the intent. The system 100 can facilitate, in whole or in part, obtaining an indication of an intent associated with a functionality of a communication network; defining, based on the obtaining of the indication, at least one attribute; identifying a residual resource capacity; determining, based on the identifying, that the residual resource capacity is sufficient to meet a resource demand represented by the at least one attribute, resulting in a first determination; and based on the first determination, deploying the residual resource capacity to fulfill the intent, resulting in deployed resources. The system 100 can facilitate, in whole or in part, obtaining, by a processing system including a processor, an indication of an intent associated with a communication service; defining, by the processing system and based on the obtaining of the indication, a plurality of attributes; identifying, by the processing system, a residual resource capacity relative to resources allocated to a baseline load; determining, by the processing system and based on the identifying, that the residual resource capacity is sufficient to meet a resource demand represented by the plurality of attributes; and allocating, by the processing system and based on the determining, at least a portion of the residual resource capacity to fulfill the intent.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure may facilitate an end-to-end pipeline that may be used to automate network slice planning and deployment. The network slice planning and deployment may be based on user-specified intents. Feasibility of planning and deployment may be assessed or verified by historical data and/or real-time data pertaining to resource utilization. Suggestions for modifying the intents may be offered to enhance the planning and deployment of network slices.

Aspects of this disclosure may be used to position a network/system operator or service provider at the forefront of a rapidly evolving communications services landscape by providing robust technical solutions/support, while enabling user-customized services. Various embodiments may support network slicing in a generation/creation of network services tailored to user-specific requirements or intents. Network slicing demands may be satisfied and may be marked by precision and reliability via an integration of user-specified intents with advanced data analytics and automation (e.g., automation facilitated via artificial intelligence (AI) and/or machine learning (ML)).

An end-to-end pipeline of this disclosure may dynamically plan for network slicing services. Via an application of statistical, ML based prediction algorithms and generative AI technologies, efficiencies in network/system resource allocation and utilization may be enhanced. Aspects of this disclosure may be used to better understand high-level network/system service requirements, which in turn may be used to precisely and accurately drive/invoke decision-making processes or logic to achieve/realize results or solutions that satisfy those requirements. As an example, resource or device configurations may be selected to achieve particular key performance indicators (KPIs) in the face of dynamic operating conditions or circumstances.

Various embodiments of this disclosure may combine historical data and real-time data, with user-specified intents, to evaluate the feasibility of network slicing demands. By analyzing operational data, use/deployment of existing resources may be enhanced. This data-driven approach may ensure an accurate, reliable, and up-to-date resource availability prediction leading to enhancements in performance.

Aspects of this disclosure may enable a monetization of resources by establishing user-customized network/system services (e.g., network slices) that can satisfy user-specific network/system requirements and services. Such a monetization may be facilitated via automation, with an ability to provide for enhanced services in the future.

Aspects of this disclosure may enable closer coordination between various teams of personnel, such as Business Support System (BSS) personnel and backend operational/operations support system (OSS) personnel (e.g., radio access network (RAN) engineers). For example, aspects of this disclosure may enable BSS personnel to provide (real-time) feasibility assessments regarding potential customized network/system services, eliminating a need for deep technical knowledge. This immediately available and highly-accurate/informed interaction may boost confidence, leading to higher conversion rates and shorter sales cycles. Further, by streamlining the communication between the teams, less specialized training/education may be required to understand network/system technologies, as high-level intents may be readily translated into low-level technical requirements or specifications. This reduction in training/education may lead to cost savings and faster onboarding of staff. In addition, operational efficiencies may be enhanced as teams (e.g., OSS teams) may be able to more readily/easily focus on maintaining and improving a network/system, rather than being involved in customer interactions.

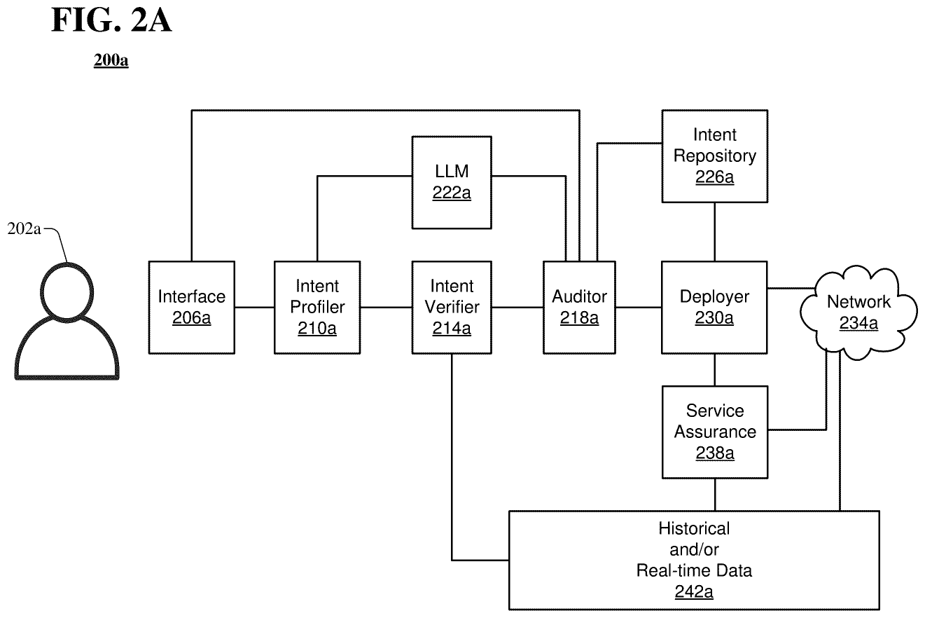

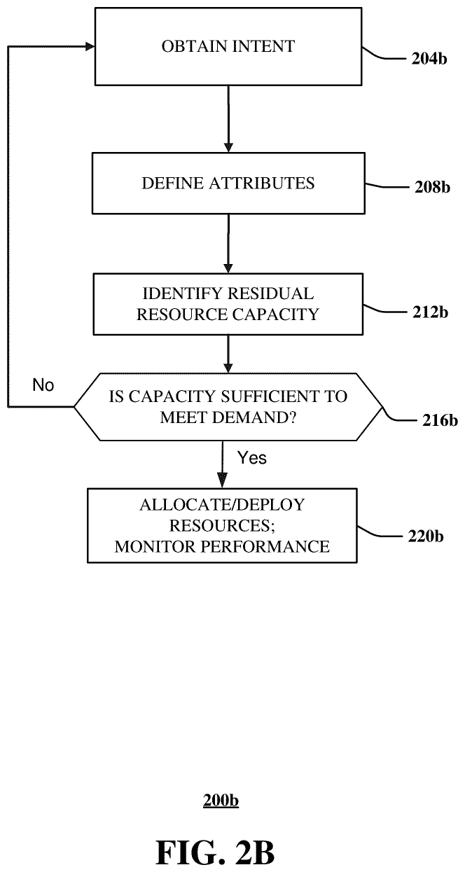

With the foregoing in mind, reference may now be made to FIG. 2A, which is a block diagram illustrating an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1. A user 202a may interact with various entities or modules of the system 200a to achieve functionalities set forth herein. For example, the user 202a may interact with one or more of the entities to realize a deployment of network resources to facilitate communication services. The entities may include an interface 206a, an intent profiler 210a, an intent verifier 214a, an auditor 218a, a large language model (LLM) 222a, an intent repository 226a, a deployer 230a, a network 234a, a service assurance 238a, and/or historical and/or real-time data 242a.

In some embodiments, one or more of the aforementioned entities may be implemented using hardware, software, firmware, or any combination thereof. Various types of technologies, platforms, and the like, may be utilized in conjunction with one or more parts/portions of the system 200a. Lines are used to show a communicative coupling between various ones of the entities in FIG. 2A. The arrangement of FIG. 2A is by no means exhaustive, which is to say that other arrangements may be utilized in various embodiments. Furthermore, one or more of the entities shown in FIG. 2A may be optional in a given embodiment and/or one or more additional entities not shown in FIG. 2A may be included. In this respect, the system 200a of FIG. 2A is illustrative of an environment where aspects of this disclosure may be implemented, with the understanding that other environments or configurations may be utilized without departing from the scope and spirit of this disclosure.

The interface 206a, which may include a graphical user interface (GUI), may serve as a one-stop platform where the user 202a can input network intents, obtain feedback, and interact using natural language (NL).

The intent profiler 210a, which may include or be associated with the LLM 222a, may extract key characteristics pertaining to network slice requirements.

The intent verifier 214a may leverage the data 242a to predict residual network capacity and assess whether resources required by the user-defined/user-expressed intent (as potentially captured via the interface 206a and the intent profiler 210a) can be accommodated.

The auditor 218a may be used to ensure that any inputs that are obtained/received are accurate, relevant, and compliant with one or more guidelines, technical specifications, requirements, or the like, before forwarding a respective input (or a result of processing the input) to a targeted destination. In this respect, and by way of example, the auditor 218a may work in unison with the deployer 230a to control a deployment of resources into/onto the network 234a. Decisions to deploy resources (or analogously, decisions not to deploy resources) may be captured by/within the intent repository 226a, which may serve as a store/database of information that may be accessed by the auditor 218a for future uses/assessments. The auditor 218a may leverage/collaborate with the LLM 222a for information processing purposes. To the extent that the auditor 218a identifies any deficiencies, the auditor 218a may return an indication/identification of the same to, e.g., the interface 206a for purposes of providing feedback to the user 202a. In this manner, the user 202a may have an ability to engage with the system 200a to refine intent based on the availabilities or capabilities of the resources that are available to achieve/realize a particular objective or purpose.

It is noted that interconnectivity between various ones of the interfaces may be facilitated via one or more types or kinds of application programming interfaces (APIs). For example, a NL-driven API may be used in conjunction with one or more parts/portions of the system 200a. In some embodiments, a representational state transfer (REST) API may be used in conjunction with one or more parts/portions of the system 200a.

The interface 206a may provide a user-friendly visualization tool, such as a chatbot GUI. Feedback may be displayed in natural language (NL) for easy readability, and user inputs (as provided by, e.g., the user 202a) may be forwarded to appropriate modules or entities for processing. The interface 206a may provide an ability for the user 202a (or another user) to review a conversation history and seamlessly interact with various ones of the entities/modules of the system 200a. In some embodiments, the interface 206a may provide a dashboard, or the like, that may enable a selection of various options. In some embodiments, the interface 206a may provide/present the options as part of one or more menus (or the like).

The LLM 222a may be derived through/via one or more approaches or techniques. For example, the LLM 222a may be based on a prompt engineering technique that may utilize carefully crafted prompts, tailored messages, and domain-specific examples. The LLM 222a may be based on a retrieval-augmented generation (RAG) technique that may use a database (e.g., a vector database) containing domain-specific documents (e.g., network operational data schemas, specifications (such as specifications promulgated by the Third Generation Partnership Project (3GPP)), and the like). The LLM 222a may be based on a fine-tuned LLM or model that may process outputs of a pre-trained LLM with/using domain-specific data (e.g., specific network data). In some embodiments, two or more of the approaches or techniques may be utilized, which is to say that an LLM 222a in a given embodiment may correspond to a blend of two or more of the approaches/techniques. In terms of prompt engineering, zero-shot (no examples), single-shot (one example), and/or few-shot (multiple examples) approaches may be used.

The intent profiler 210a may be primed with a set of characteristics/parameters that may pertain to the network 234a. By way of example, and without limitation, the set of characteristics/parameters may include or pertain to: a number of users, a direction (e.g., downlink, uplink), traffic demand, starting time, ending time, location (as potentially expressed in one or more dimensions), coverage, bandwidth, interference, noise, transmission power, receiver sensitivity, frequencies/frequency bands/spectrum, encryption/decryption, modulation/demodulation, etc. The characteristics/parameters may correspond to key performance indicators (KPIs) and/or may define/establish network slicing requirements. The LLM 222a may be used to extract information based on the characteristics/parameters and may structure the information in one or more machine-readable formats (e.g., a JSON format). Once the characteristics/parameters are successfully extracted, the formulation of the intent may be complete, and the structured outputs may be provided to, e.g., the intent verifier 214a. To the extent that any information supportive of one or more characteristics/parameters is missing/absent, the procedure may return to the information extraction/intent collection step, where the LLM 222a may generate NL prompts to request additional information from the user 202a. If the expression of any intent remains incomplete or unclear after some number of attempts to gather information from the user 202a, the LLM 222a may provide the user 202a with a detailed set of instructions or guidance articulating network intent or assumptions that are/will be made.

The intent verifier 214a may utilize/provide intent translation to convert the output(s) from the intent profiler 210a into a deployment-level/deployment-ready specification. The conversion may involve mapping user-defined requirements to deployment parameters, such as mapping or translating: the number of users, direction, and traffic demand to uplink/downlink resource demands; start and end timestamps to a service period; location and coverage to identifiers of cells in a RAN that can provide the required radio resources, etc. The results of the conversion/mapping/translation may inform a resource prediction process of the intent verifier 214a by specifying key conditions, such as the prediction period, involved cells, and data traffic directions, for example. The resource prediction process may then generate an estimate of residual network capacity based on these conditions (and potentially other conditions), which may be based in part on the data 242a. An intent assessment process of the intent verifier 214a may evaluate whether the estimated residual network capacity can accommodate the user-defined intent based. The results of these analyses as generated by the intent verifier 214a may be provided to the auditor 218a.

As an illustrative example of operations that may be facilitated by the intent verifier 214a, it may be assumed that a user-specified start and end time and location may define a service period and a service/coverage area. From this information, available cells for facilitating a communication service (or set of communication services) may be determined/identified. Resource demand may be interpreted in terms of a number of physical resource blocks (PRBs) that may be needed to facilitate the communication service(s). Spectral efficiency (SE) may be a representation that may be used in terms of a translation or mapping of traffic demand into required PRBs. For example, SE may be used as a basis for assessing whether the required PRBs for the service(s) are available from/within a pool of PRBs. In some embodiments, classification or clustering techniques may be utilized to identify patterns in resource usage (and any statistics associated therewith), which may help to guide resource predictions. Still further, various types of models or algorithms may be used to enhance predictions or classifications. For example, a supervised or semi-supervised learning model may utilize a self-learning technique to enhance classification accuracy and support predictions.

Predictions may be based on an analysis of past data and/or current (e.g., real-time) data, with an ability to de-emphasize (e.g., disregard/discard) data/information that is representative of a (statistical) outlier and emphasize data/information that is likely/probabilistically representative of current or future states or conditions. To the extent that any information/data is missing/omitted, interpolation techniques (or other techniques) may be utilized to supply or infer the missing/omitted information/data.

The auditor 218a may facilitate/provide a number of functions or operations. For example, the auditor 218a may interact with the LLM 222a to generate feedback for the user 202a in respect of the analysis results (e.g., deployment-level specifications of the original intent, or any adjusted/modified intent with its associated deployment-level specifications) generated by the intent verifier 214a. Based on this interaction, the LLM 222a may generate a natural language (NL) summary of the analysis and may send/provide the same to the auditor 218a for review. The auditor 218a may review the NL summary, and based on that review, may opt to revise/refine the NL summary (resulting in a modified NL summary). The auditor 218a may send the NL summary (or the modified NL summary, as applicable) to the user 202a (by way of the interface 206a). The auditor 218a may, based on sending the NL summary (or modified NL summary), receive feedback from the user 202a (by way of the interface 206a). This feedback may result in an iterative process, whereby additional NL summaries may be generated until the user 202a is satisfied with the results (or some timeout or other threshold, such as a maximum number of retries, has been reached). Assuming that the user 202a is satisfied with the results (based on the initial expressed intent being fulfilled, or an adjusted intent is acceptable to the user 202a), the auditor 218a may provide actionable network specifications to, e.g., the deployer 230a for potential deployment. In some embodiments, prior to authorizing the deployer 230a to facilitate the deployment, a (final) verification step may be executed to determine if the network intent should be adopted. Assuming that deployment is proper (e.g., the verification step yields an affirmative indication), the deployment specifications may be executed by the deployer 230a to facilitate a deployment of resources in/as part of the network 234a. Conversely, if the deployment is improper (e.g., the verification step yields a negative indication), the intent and the associated deployment specification(s) may be stored in the repository 226a, which may be used to archive intents (and associated specification(s)) awaiting deployment confirmation/approval. The auditor 218a may generate a confirmation, a message, a transcript, a report, or the like, that may be provided to the user 202a (potentially via the interface 206a) indicating actions/deployments that were taken (or, analogously, actions/deployments that were not taken, were deferred, are in a state of waiting on action or further information, etc.). To the extent that any further action is required of the user 202a (such as, for example, in relation to intent(s) contained in/referenced by the repository 226a), the auditor 218a may help to facilitate a resolution of the same.

The service assurance module/entity 238a may serve to monitor the network deployments (as facilitated by the deployer 230a, for example) relative to the expressed (initial or adjusted) intent, potentially as a function of one or more requirements or specifications. The service assurance module 238a may have access to the data 242a as generated by/within the network 234a (which may, illustratively, include or encompass a RAN network, a transport network, a core network, etc.), and may perform analyses against the data 242a to generate indicators of whether the expressed intent has been/is being satisfied. To the extent that the network performance fails to satisfy the expressed intent, one or more adjustments may be triggered by the service assurance module 238a (or other entity or module).

Based on the foregoing, it is understood and appreciated that the intent verifier 214a may be utilized to check the feasibility of a slice that the intent verifier may obtain from, e.g., the data 242a. As described above, the deployer 230a may selectively choose whether to deploy a slice onto the network 234a. To the extent that the deployer 230a opts/elects to deploy the slice onto the network 234a, the deployer 230a may notify the service assurance module 238a, which may serve as a trigger to track/monitor the slice. In this regard, the service assurance module 238a may achieve associated tasks/functionalities by obtaining the data 242a (e.g., historical and/or real-time data) to monitor the performance of the slice. Service assurance 238a monitoring may result in changes to a network/system configuration, potentially depending on whether the service assurance is operating in a closed-loop or open-loop manner.

It is appreciated that the specific depiction of the system 200a shown in FIG. 2A is illustrative, which is to say that modifications or adaptations may be made without departing from the scope and spirit of this disclosure. The various modules/entities shown in FIG. 2A may be communicatively coupled to one another via a variety of techniques, channels, links, mediums, or the like. For example, various ones of the entities may be coupled to one another via unidirectional links, bidirectional links, etc.

Referring now to FIG. 2B, an illustrative embodiment of a method 200b in accordance with various aspects described herein is shown. The method 200b may be implemented or executed, in whole or in part, in conjunction with one or more systems, devices, and/or components, such as for example the systems, devices, and components set forth herein. In some embodiments, the method 200b may be wholly or partially implemented or executed via one or more processing systems, where each such processing system may include one or more processors. Further, in some embodiments, operations of the method 200b may be embodied as instructions that may be executed by one or more processing systems to obtain/realize the functionality associated therewith. The instructions may be stored in one or more forms and/or in respect of one or more entities, such as a memory, a transitory or non-transitory computer-readable or machine-readable medium, etc. Various operations facilitated via the method 200b are described below in relation to the blocks shown in FIG. 2B. In some embodiments, one or more blocks or operations may be based on one or more other blocks or operations.

In block 204b, the intent of one or more users may be obtained. For example, in respect of a deployment, management, or refinement of a communication network, the operations of block 204b may include an indication of an application, function, or service that is desired to be implemented as part of the communication network. Block 204b may include a user utilizing an interface (e.g., a GUI) to describe, potentially in natural language (NL) terms, a description of an application, function, or service that is desired. Block 204b may invoke/utilize machine learning and/or artificial intelligence to refine any inputs that the user provides as part of block 204b. In this respect, it is understood that the intent may be obtained in conjunction with an iterative procedure/process.

In block 208b, one or more characteristics, parameters, attributes, or the like, may be defined or established based on the intent obtained/captured as part of block 204b. For example, the intent as expressed in NL as part of block 204b may be subjected to a translation or mapping to a technical specification or requirement. As an illustrative example, if the user, as part of block 204b, requested an ability to provide “high-definition streaming video capabilities” on a particular date and time (e.g., Jan. 1, 2025 at 12:30 AM Eastern), and at a particular location (New York City), high-definition in this context may be resolved to a requirement of at least 1080p quality.

In block 212b, a residual resource capacity may be determined/identified. As used in this context, there may be a baseline or baseload of demand that may need to be satisfied, in addition to whatever other application, functions, or services are desired or needed. In this respect, any residual resource capacity may include capacity that is leftover/remaining after accounting for/deducting a (pre-)existing allocation of capacity/resources to satisfy the baseload. It is noted that, in this respect, aspects of block 212b may include predictions regarding future baseload demand, such as for example in relation to an intention to provision an application, function, or service at some point in the future as part of block 204b.

In block 216b, a determination may be made whether the residual resource capacity determined/identified in block 216b is sufficient to meet the resource demand as defined by/in the attributes of block 208b. Assuming that it is, flow may proceed to block 220b; otherwise, flow may proceed from block 216b to block 204b.

As part of the flow from block 216b to block 204b, feedback may be provided to the user(s). The feedback may include an indication that, based on the expressed intent, that the intent cannot be satisfied. In some embodiments, the feedback may include an indication of one or more reasons why the intent cannot be satisfied. The feedback may include a recommendation that may allow the intent (or one or more parts/portions thereof) to be satisfied. To demonstrate, and continuing the example set forth above, an option may be provided to allow for “high-definition streaming video capabilities” in New York City on Jan. 1, 2025 at 1:30 AM Eastern (e.g., an hour after originally specified).

As one skilled in the art will appreciate, the flow from block 216b to block 204b may effectively establish a loop, whereby it may be possible to converge upon a solution, configuration, deployment of resources, or the like, that reasonably satisfies a user (or set of users) (within a threshold), while at the same time assisting a network/system operator or service provider with efficiently utilizing scarce communication resources.

In block 220b, resources (of the residual resource capacity) may be allocated and deployed in accordance with the attributes defined as part of block 208b. The allocation/deployment may correspond to one or more network slices. As part of block 220b, performance of the deployed resources may be monitored, to ensure compliance with the attributes of block 208b for example (where such attributes are based on the expressed intent). To the extent that there are any departures from expectation (potentially as a function of exceeding or satisfying one or more thresholds), modifications may be enacted to bring performance back into compliance, a user may be notified/contacted/alerted and may be requested to provide input in view of the same, etc.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described above, aspects of this disclosure may provide an ability for a user to interact with a system by way of one or more interfaces. In some embodiments, the system may be tasked with managing and deploying resources as part of practical applications involving a provisioning of one or more communication services. Aspects of this disclosure may utilize or support natural language (NL) processing techniques by leveraging the vast scope and reach of various models, such as large language models (LLMs). Artificial intelligence and machine learning technologies may be used to infer user intent, which can lead to high-quality/highly-accurate applications and network slice deployments for facilitating communication services. Furthermore, aspects of this disclosure may reduce the number of errors (informally: bugs) that may be present in an application, which in turn can enhance QoS or QoE and reduce customer/subscriber churn. To the extent that a resource allocation/deployment fails to satisfy one or more parameters of expressed intent, an ability is provided to monitor for such a state/condition and proactively provide recommendations or suggestions for remedying the same. Stated differently, aspects of this disclosure may facilitate a self-healing process or procedure, whereby errors (or other types of shortfalls or shortcomings) may be addressed or corrected, potentially without requiring human intervention, possibly even before such errors manifest themselves at a customer or subscriber location/end of a data transfer/transaction. In brief, and as demonstrated herein, the various aspects of this disclosure are directed to practical applications representative of substantial improvements to technology in relation to a provisioning of communication services. In this regard, and as one skilled in the art will appreciate, the various aspects of this disclosure are not directed to abstract ideas. To the contrary, the various aspects of this disclosure are directed to, and encompass, significantly more than any abstract idea standing alone. Indeed, the various aspects of this disclosure are used to generate transformative, useful, concrete, and tangible results in respect of a provisioning of communication services as part of one or more communication networks/systems.

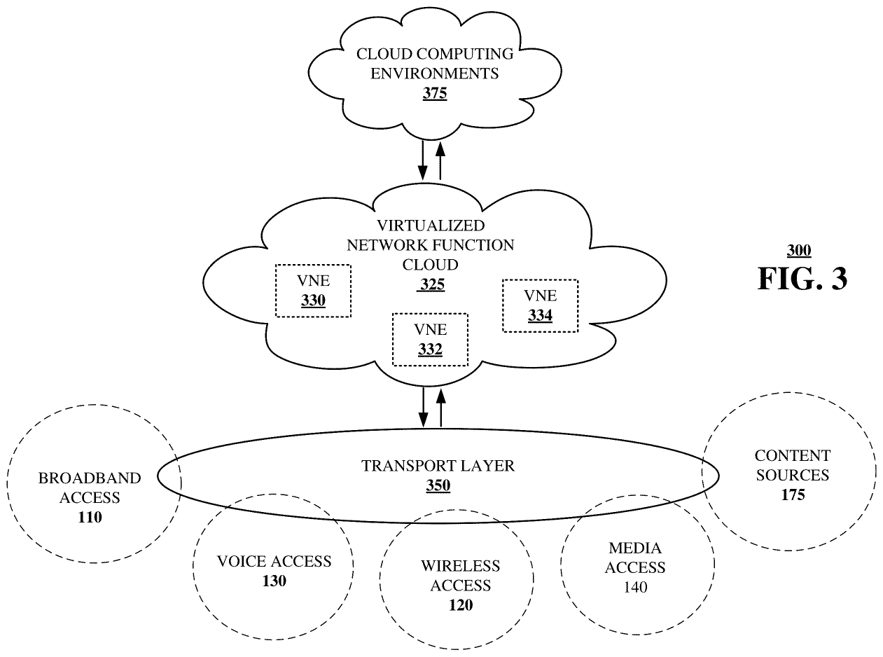

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200b presented in FIGS. 1, 2A, and 2B. For example, the virtualized communication network 300 can facilitate, in whole or in part, obtaining an indication of an intent associated with a communication network; defining, based on the obtaining of the indication, a plurality of attributes; identifying a residual resource capacity; determining, based on the identifying, whether the residual resource capacity is sufficient to meet a resource demand represented by the plurality of attributes, resulting in a first determination; and based on the first determination indicating that the residual resource capacity is sufficient to meet the resource demand represented by the plurality of attributes, deploying at least a portion of the residual resource capacity to fulfill the intent. The virtualized communication network 300 can facilitate, in whole or in part, obtaining an indication of an intent associated with a functionality of a communication network; defining, based on the obtaining of the indication, at least one attribute; identifying a residual resource capacity; determining, based on the identifying, that the residual resource capacity is sufficient to meet a resource demand represented by the at least one attribute, resulting in a first determination; and based on the first determination, deploying the residual resource capacity to fulfill the intent, resulting in deployed resources. The virtualized communication network 300 can facilitate, in whole or in part, obtaining, by a processing system including a processor, an indication of an intent associated with a communication service; defining, by the processing system and based on the obtaining of the indication, a plurality of attributes; identifying, by the processing system, a residual resource capacity relative to resources allocated to a baseline load; determining, by the processing system and based on the identifying, that the residual resource capacity is sufficient to meet a resource demand represented by the plurality of attributes; and allocating, by the processing system and based on the determining, at least a portion of the residual resource capacity to fulfill the intent.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

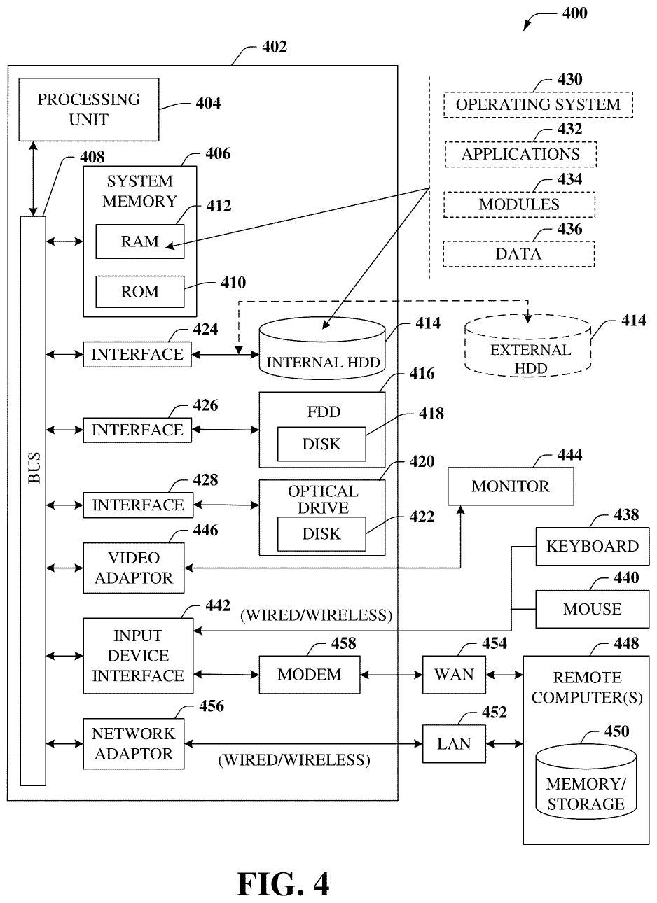

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, obtaining an indication of an intent associated with a communication network; defining, based on the obtaining of the indication, a plurality of attributes; identifying a residual resource capacity; determining, based on the identifying, whether the residual resource capacity is sufficient to meet a resource demand represented by the plurality of attributes, resulting in a first determination; and based on the first determination indicating that the residual resource capacity is sufficient to meet the resource demand represented by the plurality of attributes, deploying at least a portion of the residual resource capacity to fulfill the intent. The computing environment 400 can facilitate, in whole or in part, obtaining an indication of an intent associated with a functionality of a communication network; defining, based on the obtaining of the indication, at least one attribute; identifying a residual resource capacity; determining, based on the identifying, that the residual resource capacity is sufficient to meet a resource demand represented by the at least one attribute, resulting in a first determination; and based on the first determination, deploying the residual resource capacity to fulfill the intent, resulting in deployed resources. The computing environment 400 can facilitate, in whole or in part, obtaining, by a processing system including a processor, an indication of an intent associated with a communication service; defining, by the processing system and based on the obtaining of the indication, a plurality of attributes; identifying, by the processing system, a residual resource capacity relative to resources allocated to a baseline load; determining, by the processing system and based on the identifying, that the residual resource capacity is sufficient to meet a resource demand represented by the plurality of attributes; and allocating, by the processing system and based on the determining, at least a portion of the residual resource capacity to fulfill the intent.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

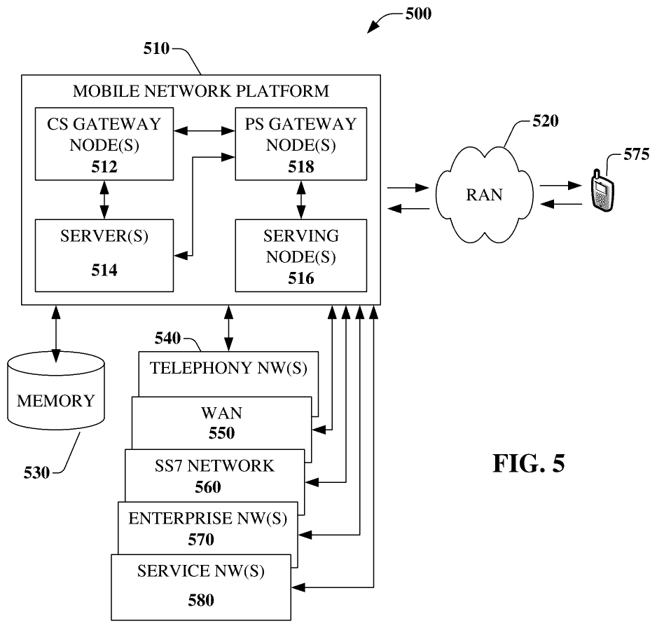

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, obtaining an indication of an intent associated with a communication network; defining, based on the obtaining of the indication, a plurality of attributes; identifying a residual resource capacity; determining, based on the identifying, whether the residual resource capacity is sufficient to meet a resource demand represented by the plurality of attributes, resulting in a first determination; and based on the first determination indicating that the residual resource capacity is sufficient to meet the resource demand represented by the plurality of attributes, deploying at least a portion of the residual resource capacity to fulfill the intent. The platform 510 can facilitate, in whole or in part, obtaining an indication of an intent associated with a functionality of a communication network; defining, based on the obtaining of the indication, at least one attribute; identifying a residual resource capacity; determining, based on the identifying, that the residual resource capacity is sufficient to meet a resource demand represented by the at least one attribute, resulting in a first determination; and based on the first determination, deploying the residual resource capacity to fulfill the intent, resulting in deployed resources. The platform 510 can facilitate, in whole or in part, obtaining, by a processing system including a processor, an indication of an intent associated with a communication service; defining, by the processing system and based on the obtaining of the indication, a plurality of attributes; identifying, by the processing system, a residual resource capacity relative to resources allocated to a baseline load; determining, by the processing system and based on the identifying, that the residual resource capacity is sufficient to meet a resource demand represented by the plurality of attributes; and allocating, by the processing system and based on the determining, at least a portion of the residual resource capacity to fulfill the intent.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

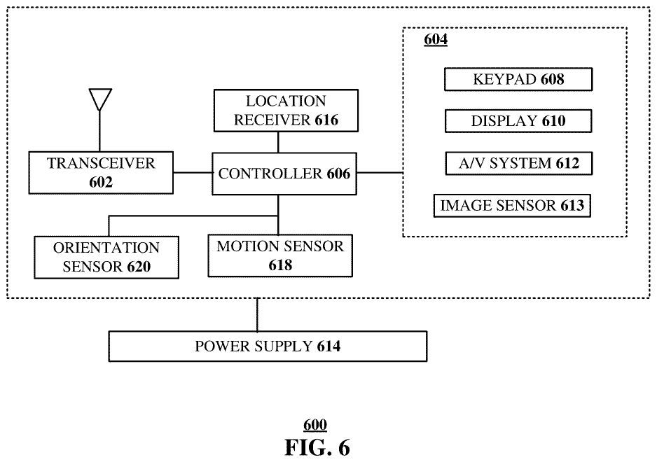

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, obtaining an indication of an intent associated with a communication network; defining, based on the obtaining of the indication, a plurality of attributes; identifying a residual resource capacity; determining, based on the identifying, whether the residual resource capacity is sufficient to meet a resource demand represented by the plurality of attributes, resulting in a first determination; and based on the first determination indicating that the residual resource capacity is sufficient to meet the resource demand represented by the plurality of attributes, deploying at least a portion of the residual resource capacity to fulfill the intent. The computing device 600 can facilitate, in whole or in part, obtaining an indication of an intent associated with a functionality of a communication network; defining, based on the obtaining of the indication, at least one attribute; identifying a residual resource capacity; determining, based on the identifying, that the residual resource capacity is sufficient to meet a resource demand represented by the at least one attribute, resulting in a first determination; and based on the first determination, deploying the residual resource capacity to fulfill the intent, resulting in deployed resources. The computing device 600 can facilitate, in whole or in part, obtaining, by a processing system including a processor, an indication of an intent associated with a communication service; defining, by the processing system and based on the obtaining of the indication, a plurality of attributes; identifying, by the processing system, a residual resource capacity relative to resources allocated to a baseline load; determining, by the processing system and based on the identifying, that the residual resource capacity is sufficient to meet a resource demand represented by the plurality of attributes; and allocating, by the processing system and based on the determining, at least a portion of the residual resource capacity to fulfill the intent.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining an indication of an intent associated with a communication network;
defining, based on the obtaining of the indication, a plurality of attributes;
identifying a residual resource capacity;
determining, based on the identifying, whether the residual resource capacity is sufficient to meet a resource demand represented by the plurality of attributes, resulting in a first determination; and
based on the first determination indicating that the residual resource capacity is sufficient to meet the resource demand represented by the plurality of attributes, deploying at least a portion of the residual resource capacity to fulfill the intent.

2. The device of claim 1, wherein the obtaining of the indication of the intent comprises obtaining the indication of the intent from at least one user.

3. The device of claim 2, wherein the at least one user includes a plurality of users.

4. The device of claim 1, wherein the obtaining of the indication of the intent comprises obtaining the indication of the intent in natural language terms.

5. The device of claim 4, wherein the operations further comprise:
translating the natural language terms to a technical specification, technical requirements, or a combination thereof,
wherein the defining of the plurality of attributes is based on the translating.

6. The device of claim 1, wherein the identifying of the residual resource capacity is based on a prediction of a baseload.

7. The device of claim 6, wherein the prediction of the baseload is based on an analysis of historical data, real-time data, or a combination thereof.

8. The device of claim 1, wherein the operations further comprise:
based on the first determination indicating that the residual resource capacity is insufficient to meet the resource demand represented by the plurality of attributes, providing feedback indicating that the residual resource capacity is insufficient.

9. The device of claim 8, wherein the feedback includes a reason why the residual resource capacity is insufficient.

10. The device of claim 8, wherein the feedback includes a recommendation for modifying the intent, corresponding to modified intent that is achievable via the residual resource capacity.

11. The device of claim 10, wherein the recommendation is based on a use of machine learning, artificial intelligence, or a combination thereof.

12. The device of claim 1, wherein the intent pertains to: an application, a function, a service, or any combination thereof.

13. The device of claim 1, wherein the operations further comprise:
based on the first determination indicating that the residual resource capacity is sufficient to meet the resource demand represented by the plurality of attributes and based on the deploying occurring at a first time, monitoring, at a second time that is subsequent to the first time, a performance of the at least a portion of the residual resource capacity.

14. The device of claim 13, wherein the operations further comprise:
based on the monitoring indicating that the performance of the at least a portion of the residual resource capacity fails to fulfill the intent at the second time, generating an alert, enacting a modification to the at least a portion of the residual resource capacity, or a combination thereof.

15. The device of claim 1, wherein the deploying of the at least a portion of the residual resource capacity to fulfill the intent comprises a utilization of a network slice.

16. The device of claim 1, wherein the defining is based on a use of a large language model.

17. A non-transitory machine-readable medium, comprising executable instructions that, when executed by a processing system including a processor, facilitate performance of operations, the operations comprising:
obtaining an indication of an intent associated with a functionality of a communication network;
defining, based on the obtaining of the indication, at least one attribute;
identifying a residual resource capacity;
determining, based on the identifying, that the residual resource capacity is sufficient to meet a resource demand represented by the at least one attribute, resulting in a first determination; and
based on the first determination, deploying the residual resource capacity to fulfill the intent, resulting in deployed resources.

18. The non-transitory machine-readable medium of claim 17, wherein the operations further comprise:
subsequent to the deploying, identifying a change in an environmental condition; and
modifying, based on the identifying of the change, a configuration associated with the deployed resources to continue fulfilling the intent.

19. A method, comprising:
obtaining, by a processing system including a processor, an indication of an intent associated with a communication service;
defining, by the processing system and based on the obtaining of the indication, a plurality of attributes;
identifying, by the processing system, a residual resource capacity relative to resources allocated to a baseline load;
determining, by the processing system and based on the identifying, that the residual resource capacity is sufficient to meet a resource demand represented by the plurality of attributes; and
allocating, by the processing system and based on the determining, at least a portion of the residual resource capacity to fulfill the intent.

20. The method of claim 19, wherein the obtaining of the indication occurs via a graphical user interface.
